(19) United States
(12) Patent Application Publication
(10) Pub. No.: US 2018/0318962 A1
(43) Pub. Date: Nov. 8, 2018

(54) METHOD FOR PROCESSING POLYCRYSTALLINE DIAMOND COMPACT HAVING CURVED SURFACE

(71) Applicant: SF DIAMOND CO., LTD., Zhengzhou (CN)

(72) Inventors: Dongpeng Zhao, Zhengzhou (CN); Hongli Li, Zhengzhou (CN); Shanshan Ma, Zhengzhou (CN); Tongjian Niu, Zhengzhou (CN); Haijiang Fang, Zhengzhou (CN)

(21) Appl. No.: 15/851,692

(22) Filed: Dec. 21, 2017

Related U.S. Application Data
(63) Continuation-in-part of application No. PCT/CN2017/105472, filed on Oct. 10, 2017.

(30) Foreign Application Priority Data
May 4, 2017 (CN) 201710308958.0

(51) Int. Cl. B23K 26/362; B23K 26/0622; B23K 26/06

(52) U.S. Cl. CPC B23K 26/362; B23K 26/0665; B23K 26/0626; B23K 26/0622

(57) ABSTRACT

A method for making a polycrystalline diamond compact (PDC). The method includes: 1) preparing a workblank of a polycrystalline diamond compact (PDC); and 2) thermally- or cold-etching the curved surface of the workblank of the polycrystalline diamond compact (PDC) using laser. The thermally- or cold-etching the curved surface of the workblank of the polycrystalline diamond compact (PDC) includes: employing a laser generator to produce a laser beam, expanding the laser beam, focusing the laser beam, to yield an energy concentration area on the surface of the workblank of the polycrystalline diamond compact, and etching the curved surface using the energy concentration area.

### CROSS-REFERENCE TO RELATED APPLICATIONS

This application is a continuation-in-part of International Patent Application No. PCT/CN2017/105472 with an international filing date of Oct. 10, 2017, designating the United States, now pending, and further claims foreign priority benefits to Chinese Patent Application No. 201710308958.0 filed May 4, 2017. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND OF THE INVENTION

### Field of the Invention

This disclosure relates to the field of super hard composite materials, and more particularly to a method for making polycrystalline diamond compacts (PDCs) having a curved surface for drill bits.

### Description of the Related Art

Currently, polycrystalline diamond compacts (PDCs) are widely used in drill bits and other downhole tools for oil and gas drilling as well as tools for construction and mining. However, conventional drill bits use PDCs with a flat top surface, exhibit relatively low working efficiency, especially in the presence of complex geological formations such as high abrasive stratum, hard rocks, and interbedded formations, and the cutting edges of the PDCs tend to break down.

Curved polycrystalline diamond compacts (e.g., cutters or inserts with uniform or non-uniform diamond thickness and non-planar diamond working surface with or without carbide substrate) can partially solve these problems. However, conventional curved polycrystalline diamond compacts are sintered and formed in one step, and, therefore, their dimensional accuracy is difficult to control. In addition, it is difficulty and inefficient to make curved PDC having complex new geometries with good geometry control and residual management.

### SUMMARY OF THE INVENTION

In view of the above-described problems, it is an objective of the invention to a method for making a polycrystalline diamond compact (PDC) having a curved surface. The method greatly improves the processing efficiency of the curved polycrystalline diamond compacts, accurately controls the geometries of the curved polycrystalline diamond compacts, and overcomes the rough operation surface facing the conventional curved polycrystalline diamond compacts.

To achieve the above objective, according to one embodiment of the invention, there is provided a method for making a polycrystalline diamond compact (PDC) having a curved surface, the method comprising: preparing a workblank of a polycrystalline diamond compact (PDC) having a flat or curved surface, and thermally- or cold-etching the curved surface of the workblank of a polycrystalline diamond compact (PDC) using laser.

In a class of this embodiment, the etching is achieved in the presence of a laser, thermally or cold.

In a class of this embodiment, thermally- or cold-etching the curved surface of the workblank of the polycrystalline diamond compact (PDC) comprises: employing a laser generator to produce a laser beam, expanding the laser beam, focusing, to yield an energy concentration area in the curved surface of the workblank of the polycrystalline diamond compact, and etching the curved surface using energy concentration area.

In a class of this embodiment, thermally-etching the surface of the workblank of the polycrystalline diamond compact is carried out according to the following parameters: the workblank of the polycrystalline diamond compact is clamped in a work table, and processed using the following parameters: a laser wavelength of 193-10600 nm, a laser pulse frequency of 100-1000 kHz, a pulse width of 1-100 ns, a beam expansion ratio between 1:2 and 1:50, and a focal length of a focus lens of 20-200 mm; the etching is performed layer by layer in the form of table movement or galvanometer matrix scanning, feeding along a Z axis, layer by layer, to yield a polycrystalline diamond compact (PDC) having a newly designed curved surface.

In a class of this embodiment, cold-etching the surface of the workblank of the polycrystalline diamond compact is carried out according to the following parameters: the workblank of the polycrystalline diamond compact is clamped in a work table, a laser wavelength is 193-10600 nm, a laser pulse frequency is 100-1000 kHz, a pulse width is 1 fs-100 ps, a beam expansion ratio is between 1:2 and 1:50, a focal length of a focus lens is 20-200 mm; the etching is performed layer by layer in the form of table movement or galvanometer matrix scanning, feeding along a Z axis, layer by layer, to yield a polycrystalline diamond compact (PDC) having a new curved surface.

The heat effect of the processed region is not obvious in the cold laser etching process, and the process poses little effect on the properties of the material.

In a class of this embodiment, the laser generator is a solid laser, a semiconductor laser, or a fiber laser.

In a class of this embodiment, the workblank of the polycrystalline diamond compact (PDC) is a planar workblank or a curved workblank; the workblank is shaped by employing diamond micro-powder and cemented carbide substrate as starting materials, and then sintering the material at a temperature of 1400-2000° C. and a pressure of 5.0-11.0 GPa.

In a class of this embodiment, a chamfering precision of the polycrystalline diamond compact is 0.01-0.1 mm, an angle precision of cutting edges of the polycrystalline diamond compact is 0.1°-0.5°, and a roughness of an upper surface of the polycrystalline diamond compact is 0.01-0.5 μm.

Advantages of the method for making a polycrystalline diamond compact (PDC) having a curved surface are summarized as follows:

1. The processing method of the invention is non-contact laser processing which employs the laser to focus on the surface of the workblank to form a high energy concentrated area, so as to vaporize and remove the unwanted part. Compared with the traditional processing methods, the processing method of the invention involves no external force, so that the equipment and the object to be processed are not subject to deformation. Compared with electromachining, the processing method of the invention does not pose the requirement of the conductivity of the object to be processed, and has no requirement for the hardness, strength and other parameters of the object to be processed.

2. The method of the invention exhibits high precision in processing a polycrystalline diamond compact (PDC) having a curved surface, can realize high precision machining on the surface of simple or complex polycrystalline diamond compacts, thus improving the efficiency of tools using polycrystalline diamond compacts as cutting elements, greatly reducing the cost of drilling, construction or mining.

### BRIEF DESCRIPTION OF THE DRAWINGS

FIG. 1 is a schematic diagram of a workblank of a polycrystalline diamond compact (PDC) having a flat surface according to one embodiment of the disclosure;

FIG. 2 is a schematic diagram of a polycrystalline diamond compact (PDC) comprising ridges according to Example 1 of the disclosure;

FIG. 3 is a schematic diagram of a polycrystalline diamond compact (PDC) comprising four cutting edges according to Example 2 of the disclosure; and

FIG. 4 is a schematic diagram of a polycrystalline diamond compact (PDC) comprising a plurality of cutting edges according to Example 3 of the disclosure.

In the drawings, the following reference numbers are used: 100. Polycrystalline diamond layer; 101. Upper surface of polycrystalline diamond compact; 200. Cemented carbide substrate; 102. Angle of chamfer; 103. Cutting edge.

### DETAILED DESCRIPTION OF THE EMBODIMENTS

To further illustrate the invention, experiments detailing a method for making a polycrystalline diamond compact (PDC) having a curved surface are described below.

The present invention uses a universal tool such as microscope to test the cutting-edge angle precision and chamfering precision of the surface polycrystalline diamond compacts, and uses a portable surface roughness tester to test the roughness of the upper surface of the polycrystalline diamond compact.

The workblank of the polycrystalline diamond compact (PDC) of the invention comprises a polycrystalline diamond layer and a cemented carbide substrate adhered to the polycrystalline diamond layer. The two elements are sintered under high temperature and high pressure conditions.

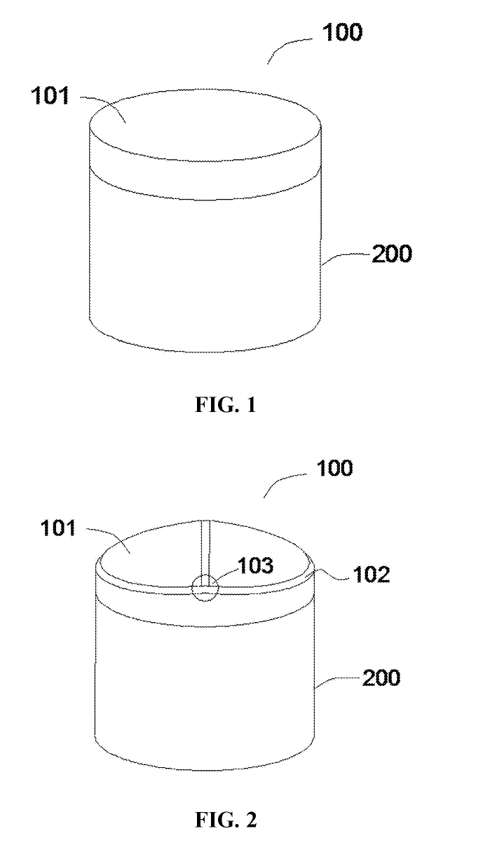

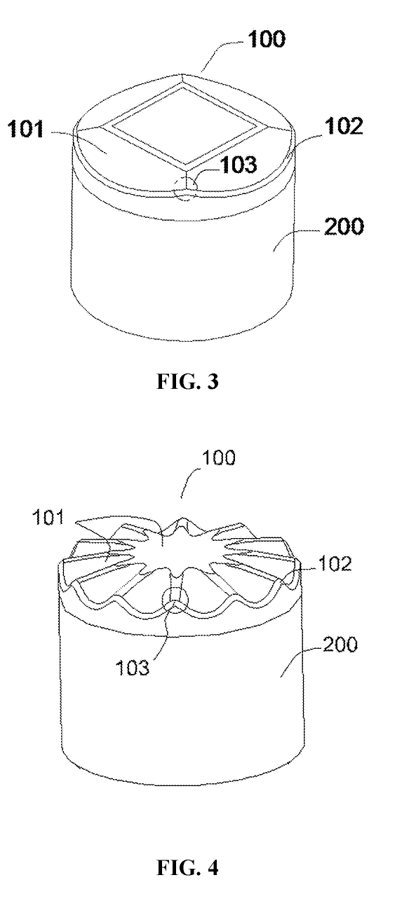

The starting materials of diamond micro-powder and cemented carbide substrate are sintered at the temperature of 1500° C. and a pressure of 9.0 GPa to yield a workblank of a flat polycrystalline diamond compact (PDC). As shown in FIG. 1, the workblank of the polycrystalline diamond compact (PDC) comprises a polycrystalline diamond layer 100 and a cemented carbide substrate 200 adhered to the polycrystalline diamond layer. The polycrystalline diamond layer comprises an upper surface 101. FIGS. 2-4 shows schematic diagrams of the prepared polycrystalline diamond compacts (PDC) having a curved surface in three examples, where 102 represents an angle of chamfer, and 103 represents a cutting edge.

The following three examples employ the workblank of the polycrystalline diamond compact in FIG. 1 for laser processing.

### Example 1

The workblank of the polycrystalline diamond compact was clamped in a work table, the laser wavelength of the solid laser was controlled at 1100 nm, a laser pulse frequency was 200 kHz, a pulse width was 80 ns, a beam expansion ratio was 1:30, a focal length of a focus lens was 30 mm; the etching was performed layer by layer in the form of galvanometer matrix scanning, feeding along a Z axis, to yield a polycrystalline diamond compact (PDC) having a curved surface.

The prepared polycrystalline diamond compact under the wavelength comprised ridges, the angle precision of cutting edges of the polycrystalline diamond compact was 0.4°, the chamfering precision of the polycrystalline diamond compact was 0.025 mm, and the roughness of the upper surface of the polycrystalline diamond compact was 0.12 μm.

The workblank of the polycrystalline diamond compact was clamped in a work table, the laser wavelength of the solid laser was controlled at 363 nm, a laser pulse frequency was 100 kHz, a pulse width was 100 ps, a beam expansion ratio was 1:20, a focal length of a focus lens was 20 mm; the etching was performed layer by layer in the form of galvanometer matrix scanning, feeding along a Z axis, to yield a polycrystalline diamond compact (PDC) having a curved surface.

The prepared curved polycrystalline diamond compact under the wavelength comprised ridges, the angle precision of cutting edges of the polycrystalline diamond compact was 0.3°, the chamfering precision of the polycrystalline diamond compact was 0.015 mm, and the roughness of the upper surface of the polycrystalline diamond compact was 0.16 μm.

The high precision ridge-shaped polycrystalline diamond compact is suitable for drilling in challenging formations such as medium to hard rocks, interbedded layers with hard rocks or inclusions.

### Example 2

The workblank of the polycrystalline diamond compact was clamped in a work table, the laser wavelength of the solid laser was controlled at 1100 nm, a laser pulse frequency was 200 kHz, a pulse width was 80 ns, a beam expansion ratio was 1:30, a focal length of a focus lens was 30 mm; the etching was performed layer by layer in the form of table moving, feeding along a Z axis, to yield a polycrystalline diamond compact (PDC) having a curved surface.

The prepared curved polycrystalline diamond compact under the wavelength comprised four cutting edges, the angle precision of cutting edges of the polycrystalline diamond compact was 0.3°, the chamfering precision of the polycrystalline diamond compact was 0.03 mm, and the roughness of the upper surface of the polycrystalline diamond compact was 0.22 μm.

The workblank of the polycrystalline diamond compact was clamped in a work table, the laser wavelength of the solid laser was controlled at 363 nm, a laser pulse frequency was 100 kHz, a pulse width was 100 ps, a beam expansion ratio was 1:20, a focal length of a focus lens was 20 mm; the etching was performed layer by layer in the form of galvanometer matrix scanning, feeding along a Z axis, to yield a polycrystalline diamond compact (PDC) having a curved surface.

The prepared curved polycrystalline diamond compact under the wavelength comprised four cutting edges, the angle precision of cutting edges of the polycrystalline diamond compact was 0.2°, the chamfering precision of the polycrystalline diamond compact was 0.028 mm, and the roughness of the upper surface of the polycrystalline diamond compact was 0.21 μm.

The high precision polycrystalline diamond compact having four cutting edges is suitable for drilling in complex strata such as hard rock, interbedded formations, with high work efficiency, thus greatly reducing the cost for drilling.

### Example 3

The workblank of the polycrystalline diamond compact was clamped in a work table, the laser wavelength of the solid laser was controlled at 1060 nm, a laser pulse frequency was 190 kHz, a pulse width was 90 ns, a beam expansion ratio was 1:30, a focal length of a focus lens was 40 mm; the etching was performed layer by layer in the form of galvanometer matrix scanning, feeding along a Z axis, to yield a polycrystalline diamond compact (PDC) having a curved surface.

The prepared curved polycrystalline diamond compact under the wavelength comprised a plurality of cutting edges, the angle precision of cutting edges of the polycrystalline diamond compact was 0.4°, the chamfering precision of the polycrystalline diamond compact was 0.045 mm, and the roughness of the upper surface of the polycrystalline diamond compact was 0.15 μm.

The workblank of the polycrystalline diamond compact having a surface was clamped in a work table, the laser wavelength of the solid laser was controlled at 363 nm, a laser pulse frequency was 100 kHz, a pulse width was 100 ps, a beam expansion ratio was 1:20, a focal length of a focus lens was 20 mm; the etching was performed layer by layer in the form of galvanometer matrix scanning, feeding along a Z axis, to yield a polycrystalline diamond compact (PDC) having a curved surface.

The prepared curved polycrystalline diamond compact under the wavelength comprised a plurality of cutting edges, the angle precision of cutting edges of the polycrystalline diamond compact was 0.4°, the chamfering precision of the polycrystalline diamond compact was 0.042 mm, and the roughness of the upper surface of the polycrystalline diamond compact was 0.18 μm.

The high precision ridge-shaped polycrystalline diamond compact is suitable for drilling in complex strata such as hard rock, interbedded formations, especially in tough interlayer and deep complex strata.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for making a polycrystalline diamond compact (PDC) having a curved surface, the method comprising:
1) preparing a workblank of a polycrystalline diamond compact (PDC) having a planar or curved surface; and
2) thermally- or cold-etching the curved surface of the workblank of the polycrystalline diamond compact (PDC) using laser.

2. The method of claim 1, wherein thermally- or cold-etching the surface of the workblank of the polycrystalline diamond compact (PDC) comprises: employing a laser generator to produce a laser beam, expanding the laser beam, focusing, to yield an energy concentration area on the surface of the workblank of the polycrystalline diamond compact, and etching the curved surface using the energy concentration area.

3. The method of claim 2, wherein the thermally-etching the surface of the workblank of the polycrystalline diamond compact is carried out according to the following parameters: the workblank of the polycrystalline diamond compact is clamped in a work table, a laser wavelength is 193-10600 nm, a laser pulse frequency is 100-1000 kHz, a pulse width is 1-100 ns, a beam expansion ratio is between 1:2 and 1:50, a focal length of a focus lens is 20-200 mm; the etching is performed layer by layer in the form of table movement or galvanometer matrix scanning, feeding along a Z axis, to yield a polycrystalline diamond compact (PDC) having a curved surface.

4. The method of claim 2, wherein the cold-etching the curved surface of the workblank of the polycrystalline diamond compact is carried out according to the following parameters: the workblank of the polycrystalline diamond compact is clamped in a work table, a laser wavelength is 193-10600 nm, a laser pulse frequency is 100-1000 kHz, a pulse width is 1 fs-100 ps, a beam expansion ratio is between 1:2 and 1:50, a focal length of a focus lens is 20-200 mm; the etching is performed layer by layer in the form of table movement or galvanometer matrix scanning, feeding along a Z axis, to yield a polycrystalline diamond compact (PDC) having a curved surface.

5. The method of claim 2, wherein the laser generator is a solid laser, a semiconductor laser, or a fiber laser.

6. The method of claim 1, wherein the workblank of the polycrystalline diamond compact (PDC) is a planar workblank or a curved workblank; the workblank is shaped by employing diamond micro-powder and cemented carbide substrate as a material, and then one-step sintering the material at a temperature of 1400-2000° C. and a pressure of 5.0-11.0 GPa.

7. The method of claim 3, wherein the workblank of the polycrystalline diamond compact (PDC) is a planar workblank or a curved workblank; the workblank is shaped by employing diamond micro-powder and cemented carbide substrate as a material, and then one-step sintering the material at a temperature of 1400-2000° C. and a pressure of 5.0-11.0 GPa.

8. The method of claim 4, wherein the workblank of the polycrystalline diamond compact (PDC) is a planar workblank or a curved workblank; the workblank is shaped by employing diamond micro-powder and cemented carbide substrate as a material, and then one-step sintering the material at a temperature of 1400-2000° C. and a pressure of 5.0-11.0 GPa.

9. The method of claim 1, wherein a chamfering precision of the polycrystalline diamond compact is 0.01-0.1 mm, an angle precision of cutting edges of the polycrystalline diamond compact is 0.1°-0.5°, and a roughness of an upper surface of the polycrystalline diamond compact is 0.01-0.5 μm.

10. The method of claim 3, wherein a chamfering precision of the polycrystalline diamond compact is 0.01-0.1 mm, an angle precision of cutting edges of the polycrystalline diamond compact is 0.1°-0.5°, and a roughness of an upper surface of the polycrystalline diamond compact is 0.01-0.5 μm.

11. The method of claim 4, wherein a chamfering precision of the polycrystalline diamond compact is 0.01-0.1 mm, an angle precision of cutting edges of the polycrystalline diamond compact is 0.1°-0.5°, and a roughness of an upper surface of the polycrystalline diamond compact is 0.01-0.5 μm.

12. A polycrystalline diamond compact (PDC) having a curved surface, the PDC having a chamfering precision of 0.01-0.1 mm, an angle precision of cutting edges of 0.1°-0.5°, and a roughness of an upper surface of 0.01-0.5 μm.
